(19) United States
(12) Patent Application Publication
(10) Pub. No.: US 2023/0195824 A1
(43) Pub. Date: Jun. 22, 2023

(54) Smart Content Redirection System

(71) Applicant: Citrix Systems, Inc., Fort Lauderdale, FL (US)

(72) Inventors: Zongpeng Qiao, Nanjing (CN); Kuriakose Mathew, Bangalore (IN); Tao Zhan, Nanjing (CN); Ze Chen, Nanning (CN)

(21) Appl. No.: 17/568,818

(22) Filed: Jan. 5, 2022

Related U.S. Application Data
(63) Continuation of application No. PCT/CN2021/138851, filed on Dec. 16, 2021.

(51) Int. Cl. G06F 16/957; G06F 16/958; G06F 16/951; G06F 9/50

(52) U.S. Cl. CPC G06F 16/957; G06F 16/958; G06F 16/951; G06F 9/5055

(57) ABSTRACT

Methods and systems for recommending content redirection are described herein. A remote computing device may establish a connection in which to transfer content between an application hosted on the remote computing device and a client device. The remote computing device may render graphics of a user interface for the application. If the remote computing device determines that to render the content of the application with use of one or more resources of the remote computing device would exceed a threshold, the remote computing device may provide, to the client device, the instructions enable the client device to render a portion of the content locally on the client device rather than on the remote computing device. In this way, the user's experience of the application may be improved without causing more computing resources on the remote computing device.

### FIELD

Aspects described herein generally relate to computer virtualization, and hardware and software related thereto. More specifically, one or more aspects described herein provide systems and methods for browser content redirection.

### BACKGROUND

Virtual applications can be executed by a remote server and made accessible by a client device using a remote protocol. The client device may display a user interface of the virtual applications that are rendered by the remote server, and allow the user to interact with the virtual applications via the user interface. The virtual applications may be configured to accomplish a variety of functions, including displaying videos obtained from a content server.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

When a video is displayed via a virtual application running on a server, rendering the video on the server and transferring the rendered video to a client device may consume a large amount of bandwidth and/or other computing resources on the server. If a high percentage of the bandwidth or other computing resources that are allocated to execute the virtual application is consumed for rendering the video and/or transferring the video, the execution of this virtual application or the entire virtual desktop may be slow, which may detrimentally affect the user experience.

To overcome limitations described above, and to overcome other limitations that will be apparent upon reading and understanding the present specification, aspects described herein are directed towards redirection of content to the client device. When a virtual application is executed on a server and is to be displayed via the virtual application, a redirection request may be sent to request the client device to render at least a portion of the content (e.g., the video) of the virtual application locally, for example to overlay the rendered content on a designated area of the user interface of the virtual application. The redirection request may be sent in response to the amount of computing resource usage to render the content exceeding or is expected to exceed a threshold. The threshold may be adjusted based on the acceptance or declination of previous redirection requests, as well as a variety of other factors. By offloading some of the processing to render content of the virtual application onto the client device, less resources are needed by the remote server to render the rest of the content of the virtual application. The result is that the entire content of the virtual application is displayed more quickly than if that content was rendered solely using resources of the remote server. This distributed approach to rendering content provides significant performance improvements in computer virtualization technology.

In at least one implementation, a remote computing device may establish a connection in which to transfer content between an application hosted on the remote computing device and a client device. The content may be processable to render graphics of a user interface for the application. The remote computing device may determine that to render the content of the application with use of one or more resources of the remote computing device would exceed a threshold and provide instructions to the client device, the instructions enable the client device to render a portion of the content locally on the client device rather than on the remote computing device.

In some instances, the one or more resources comprise at least one of: bandwidth to transmit the content; or CPU usage of a CPU, on the remote computing device, to process the content.

In some instances, the content may comprise at least a portion of a webpage.

In some instances, the remote computing device may determine that to render the content of the application with use of one or more resources of the remote computing device would exceed a threshold by receiving, an address indicating a source of at least a portion of the content; and retrieving, from a database, data indicating an average amount of resource consumption associated with causing content, from the source, to be rendered by the remote computing device.

In some instances, the remote computing device may determine that to render the content of the application with use of one or more resources of the remote computing device would exceed a threshold by monitoring current resource allocated to causing the content rendered by the remote computing device.

In some instances, the remote computing device may send a request, to the client device, to request data indicating CPU usage of a CPU on the client device and receive a response, to the request, that indicates the CPU usage of the CPU, on the client device, does not exceed a second threshold. The providing instructions are further based on the response.

In some instances, the remote computing device may further send, to the client device, a prompt to obtain the content via the client device and receive an acceptance to the prompt. The providing instructions are further based on the prompt.

In some instances, the remote computing device may further adjust, based on the acceptance to the prompt, the threshold.

In some instances, the remote computing device may further send, to the client device, a first prompt to obtain the content via the client device, receive a declination to the first prompt, determine an increased number of second client devices each has accepted a prompt to obtain a second content from a source of the content, and send, to the client device and based on the determining, a second prompt to obtain the content via the client device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5A is a block diagram of an example system in which resource management services may manage and streamline access by clients to resource feeds (via one or more gateway services) and/or software-as-a-service (SaaS) applications.

FIG. 5B is a block diagram showing an example implementation of the system shown in FIG. 5A in which various resource management services as well as a gateway service are located within a cloud computing environment.

FIG. 5C is a block diagram similar to that shown in FIG. 5B but in which the available resources are represented by a single box labeled “systems of record,” and further in which several different services are included among the resource management services.

FIG. 6 shows how a display screen may appear when an intelligent activity feed feature of a multi-resource management system, such as that shown in FIG. 5C, is employed.

FIG. 7 depicts an illustrative computing environment for content redirection in accordance with one or more illustrative aspects described herein.

FIG. 8 depicts an illustrative user interface.

FIGS. 9A to 9B depict a sequence diagram of an example method for content redirection in accordance with one or more illustrative aspects described herein.

FIG. 10 depicts a flow diagram of an example method for content redirection in accordance with one or more illustrative aspects described herein.

FIG. 11 depicts a flow diagram of an example method for updating content redirection in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

When complicated content is requested to be displayed via a virtual application hosted on a remote server, rendering the content on the remote server and/or transferring that may occupy or consume a large amount of computing resource on the remote server, and therefore the amount of computing resource left for processing other instructions or transferring other data may be significantly reduced. As a result, the speed and/or the overall performance of the virtual application may be detrimentally affected. To overcome the limitations described above, and to overcome other limitations that will be apparent upon reading and understanding the present specification, aspects described herein are directed towards content redirection to a client device from that of the virtual application. In particular, a request may be sent to client device to render the content locally, for example to overlay the rendered content on a designated area of the user interface of the virtual application. The request may be sent in response to the amount of computing resource usage to render the content exceeding or is expected to exceed a threshold. The threshold may be adjusted based on acceptance or decline of previous requests, as well as a variety of other factors. In this way, a better user experience of virtual applications may be achieved without the need to allocate more computing resources, on the remote server, to execute the virtual application.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

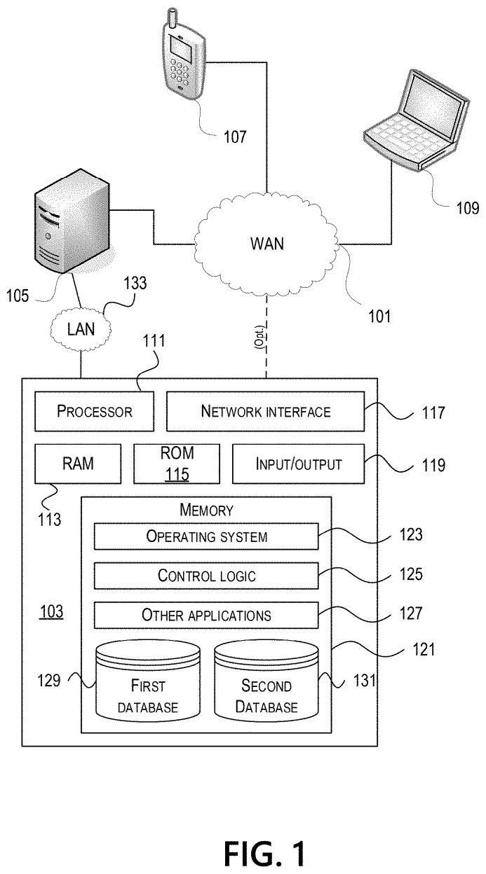

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

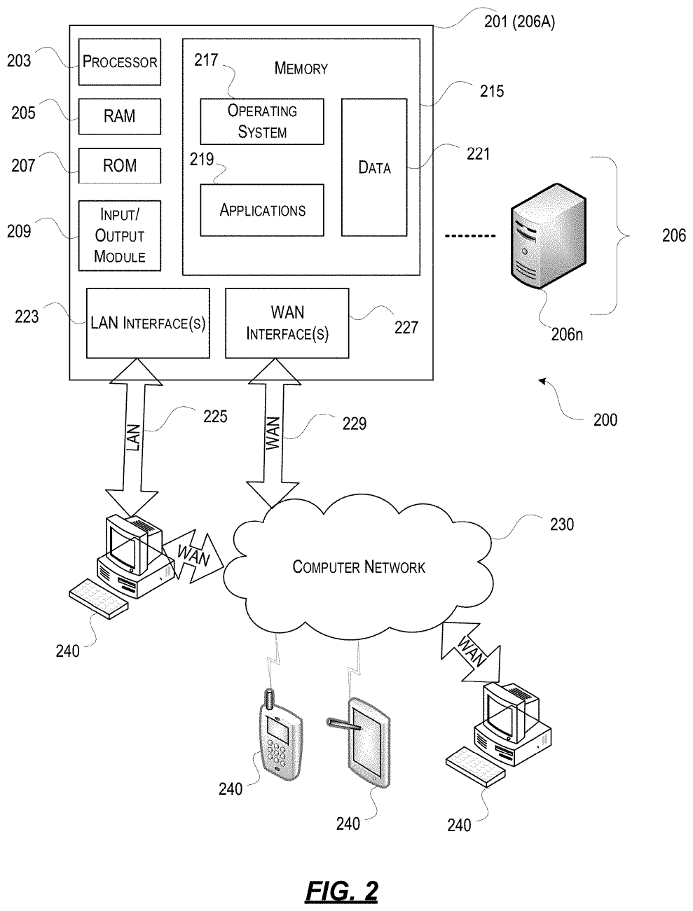

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

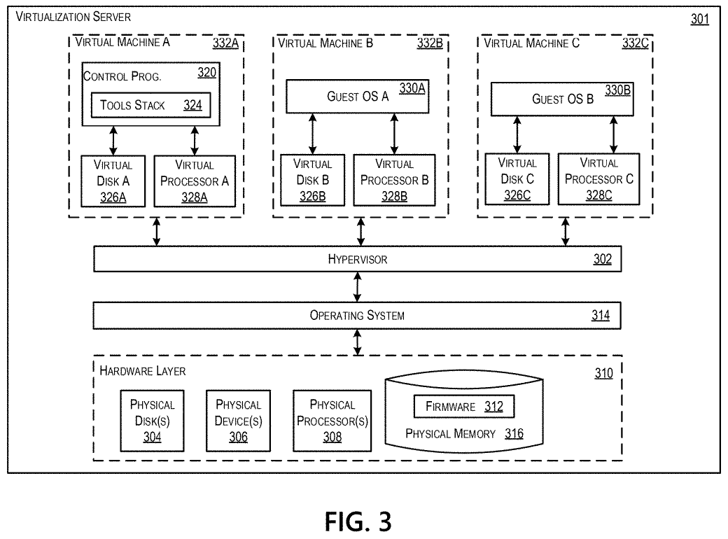

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

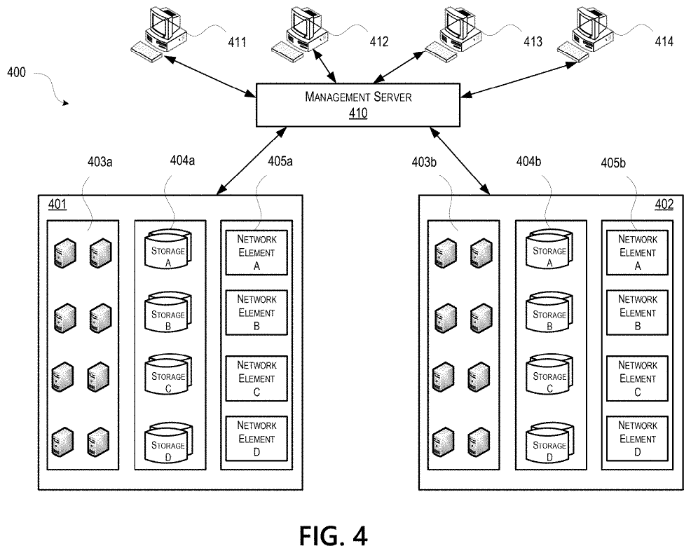

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Resource Management System

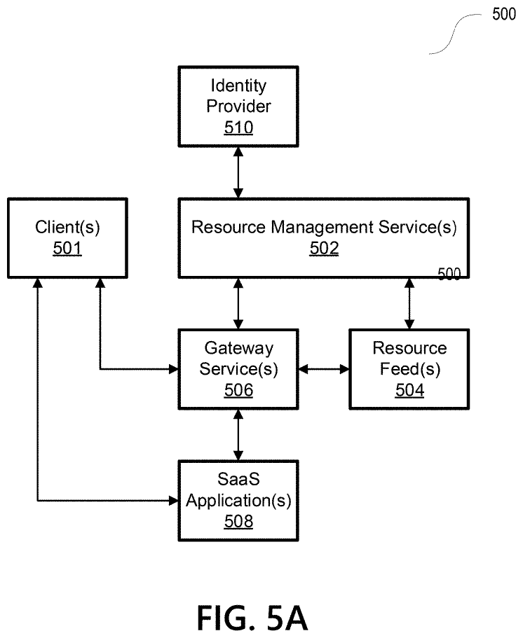

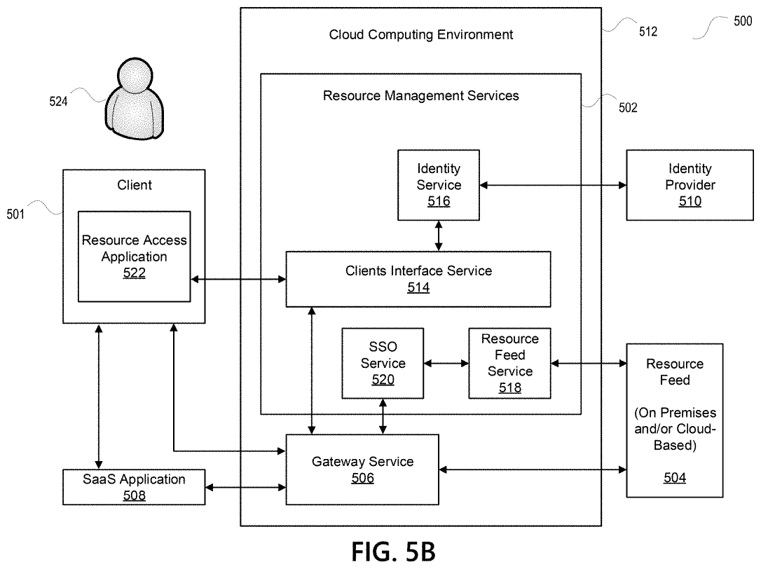

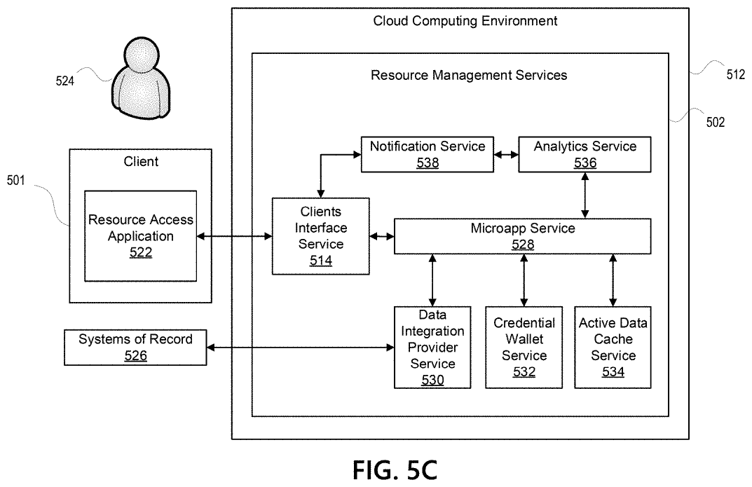

FIG. 5A is a block diagram of an example multi-resource access system 500 in which one or more resource management services 502 may manage and streamline access by one or more clients 501 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 501 and, following authentication, identify one of more resources the user is authorized to access. In response to the user selecting one of the identified resources, the resource management service(s) 502 may send appropriate access credentials to the requesting client 501, and the client 501 may then use those credentials to access the selected resource. For the resource feed(s) 504, the client 501 may use the supplied credentials to access the selected resource via a gateway service 506. For the SaaS application(s) 508, the client 501 may use the credentials to access the selected application directly.

The client(s) 501 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 501, one or more file repositories and/or file sharing systems, one or more secure browser services, one or more access control services for the SaaS applications 508, one or more management services for local applications on the client(s) 501, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 501) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 501 may use a resource access application 522 to communicate with the client interface service 514 as well as to present a user interface on the client 501 that a user 524 can operate to access the resource feed(s) 504 and/or the SaaS application(s) 508. The resource access application 522 may either be installed on the client 501, or may be executed by the client interface service 514 (or elsewhere in the multi-resource access system 500) and accessed using a web browser (not shown in FIG. 5B) on the client 501.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 501 to be redirected to the cloud-based identity service to complete an authentication process. The cloud-based identity service may then cause the client 501 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 501. The list of available resources may, for example, be presented on the user interface of the client 501 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 501, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 501 may proceed to access the selected resource.

When the user 524 selects a local application, the resource access application 522 may cause the selected local application to launch on the client 501. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 501 may then launch the identified browser and initiate a connection to the gateway service 506. The gateway service 506 may then request an assertion from the single sign-on service 520. Upon receiving the assertion, the gateway service 506 may cause the identified browser on the client 501 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 501 to access the selected SaaS application 508.

In some embodiments, the preferred browser identified by the gateway service 506 may be a specialized browser embedded in the resource access application 522 (when the resource access application 522 is installed on the client 501) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 501 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 501, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “decline,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 501 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 501. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically cause active data to be pulled from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 501 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 501 as a push notification to the user 524.

In some embodiments, a process for processing a user-initiated action via a microapp may operate as follows. The client 501 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted OAuth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

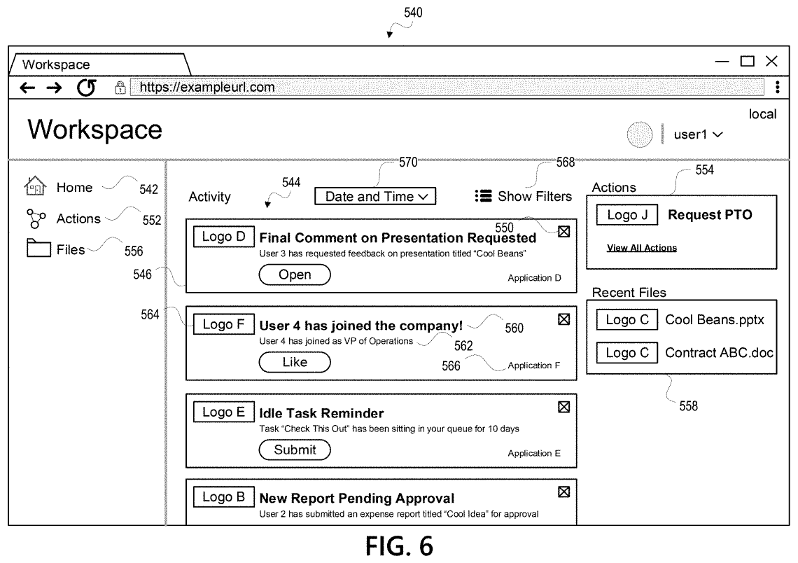

FIG. 6 shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce®, Ariba®, Concur®, RightSignature®, etc.) with which the user has accounts, and events that occur within such systems of record may be evaluated to generate notifications 546 to the user concerning actions that the user can take relating to such events. As shown in FIG. 6, in some implementations, the notifications 546 may include a title 560 and a body 562, and may also include a logo 564 and/or a name 566 of the system or record to which the notification 546 corresponds, thus helping the user understand the proper context with which to decide how best to respond to the notification 546. In some implementations, one of more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 6) and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user-interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user-interface element 552 or by selecting a desired action from a list 554 of recently and/or commonly used microapp actions. As shown, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files.

Although not shown in FIG. 6, it should be appreciated that, in some implementations, additional resources may also be accessed through the screen 540 by clicking on or otherwise selecting one or more other user interface elements that may be presented on the screen. For example, in some embodiments, one or more virtualized applications may be accessible (e.g., via a Citrix Virtual Apps and Desktops™ service) by clicking on or otherwise selecting an “apps” user-interface element (not shown) to reveal a list of accessible applications and/or one or more virtualized desktops may be accessed (e.g., via a Citrix Virtual Apps and Desktops® service) by clicking on or otherwise selecting a “desktops” user-interface element (not shown) to reveal a list of accessible desktops.

The activity feed shown in FIG. 6 provides significant benefits, as it allows a user to respond to application-specific events generated by disparate systems of record without needing to navigate to, launch, and interface with multiple different native applications.

Content Redirection

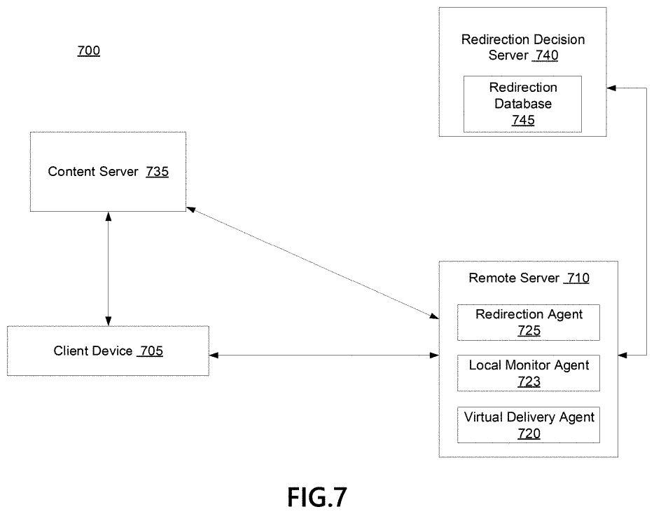

FIG. 7 depicts an illustrative computing environment for content redirection in accordance with one or more aspects described herein. The system 700 may comprise a plurality of computing devices, including client device 705, remote computing device (e.g., a remote server) 710, content server 735, and redirection decision server 740.

The client device 705 may be associated with a user. For example, the client device 705 may be a laptop, a tablet, or a mobile device of the user. The client device 705 may be the client 501 as depicted in FIGS. 5A-5C, or other computing devices. The client device 705 may communicate with a remote server 710 so that the client device 705 may access one or more virtual applications (e.g., virtual desktops or other individual applications) that are executed on the remote server 710.

The remote server 710 may include one or more computing devices and/or other computer components (e.g., processors, memories, communication interfaces, servers, server blades, or the like). For example, the remote server 710 may be and/or include any of data server 103 or web server 105 (as depicted in FIG. 1), server 206 (as depicted in FIG. 2), virtualization server 301 (as depicted in FIG. 3), management server 410 (as depicted in FIG. 4), resources management service(s) 502, cloud computing environment 512 (as depicted in FIGS. 5A-5C), or any other computing devices. The communication between the client device 705 and the remote server 710 may use a protocol (e.g., an independent computing architecture or a remote desktop protocol), and may be via a virtual delivery agent 720 on the remote server 710. The remote server 710 may host a plurality of virtual applications and provide a plurality of client devices access to the virtual applications.

If a user of the client device 705 wants to access a virtual application hosted on the remote server 710, the client device 705 establishes a connection (e.g., via the virtual delivery agent 720) with the remote server 710. The connection may be configured to transfer data between the remote server 710 and a client device 705. The remote server 710 may also establish a virtual session (or obtain a virtual session that has been established previously). The virtual session may be maintained by the remote server 710 (e.g., by a virtual machine hosted on the remote server 710). Computing resources may be allocated to host the virtual session. The computing resources may comprise bandwidth allocated to one or more channels (e.g., virtual channels, SaaS channels etc.) configured to transfer data associated with the virtual session. The computing resources may also comprise computing hardware such as processors (e.g, CPU or GPU) or memory.

The remote server 710 may execute the virtual application to render a user interface of the virtual application, and send data to the client device 705. The client device 705 may display the rendered user interface via a display on or communicatively connected with the client device 705.

The display of the virtual application may include content (e.g., a video, a picture, text, or a webpage) obtained from a content server 735. The content server 735 may be a physical device independent from the remote server 710 or may be located on the same physical device as the remote server 710. Content obtained from the content server 735 may be displayed via a web browser, a browser container, or a browser engine embedded into the virtual application, or may be displayed via other types of modules of the virtual application. For example, the browser container may be Chromium Embedded Framework (CEF) container.

If content from a content server 735 is displayed via the virtual application, the remote server 710 may have different options about how the content is obtained and rendered. For example, the remote server 710 may operate under one of the three modes. Under the first mode, which may be referred to as a “server fetch and server render” mode, the remote server 710 may obtain the content from the content server 735, render the content within the user interface of the virtual application, and then send, to the client device 705, the rendered content. Under the second mode, which may be referred to as a “server fetch and client render” mode, the remote server 710 may obtain the content from the content server 735, send the data to the client device 705 without rendering the content. The remote server 710 may also send an instruction to instruct the client device 705 to render the content. After the content is rendered, the client device 705 may, for example, overlay the rendered content to a designated area of the user interface of the virtual application, so that the content appears as a part of the user interface. Under the third mode, which may be referred to as “client fetch and client render” mode, the remote server 710 may send an instruction to the client device 705, instructing the client device 705 to obtain the content from the content server 735, and then render the content similar to as described in the second mode. Under either the second mode or the third mode (referred to as a client render mode), the remote server 710 may save computing resources (e.g., processors and memory) for rendering the content. Under the client fetch and client render mode, the remote server 710 may further save the bandwidth used to obtain the content from the content server 735 and/or the bandwidth used to transfer the content to the client device 705.

The remote server 710 may comprise a virtual delivery agent 720, a local monitor agent 723, and a redirection agent 725. As discussed above, the virtual delivery agent 720 may be configured to communicate with the client device 705 to transfer data (e.g., content or instructions) from and/or to the virtual application. The local monitor agent 723 may be configured to monitor computing resources consumption or usage on the remote server 710. The local monitor agent 723 may obtain resource consumption data by calling a system application programming interface (API). The redirection agent 725 may be configured to communicate with the redirection decision server 740 to obtain redirection instructions. Any two of the virtual delivery agent 720, the local monitor agent 723, and the redirection agent 725 may communicate with each other. For example, the local monitor agent 723 may send resource consumption data to the redirection agent 725 to facilitate the redirection agent 725 to obtain a redirection instruction. The communication between the local monitor agent 723 and the redirection agent 725 may be made by native messaging. In another example, the redirection agent 725 may send the redirection instructions to the client device 705 via the virtual delivery agent 720.

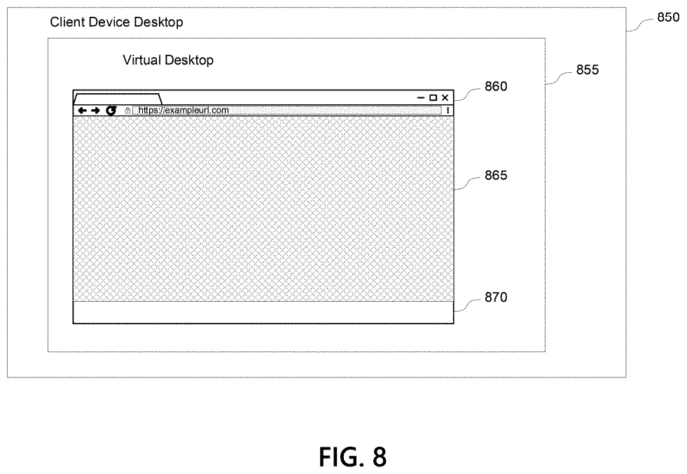

FIG. 8 depicts a user interface to illustrate the three modes as discussed above. A user interface of a client device desktop 850 may be a graphical user interface showing the desktop of the client device 705′s local desktop (e.g., a graphical user interface of a Windows® desktop). The user interface of the client device desktop 850 may comprise an area in which to display a user interface of a virtual desktop 855. The virtual desktop 855 may be executed and rendered by the remote server 710 and then sent to the client device 705. The user interface of the virtual desktop 855 may comprise a web browser. The web browser may comprise three portions. The top portion 860 and the bottom portion 870 may be configured to display options and settings of the web browser, while the middle portion 865 may display content (e.g., a web page) obtained from a content server 735. Areas of the user interface of the virtual desktop 855, except for the middle portion 865 of the web browser, may be rendered by the remote server 710 under all three modes. Under the “server fetch and server render” mode, the middle portion 865 may be also rendered by the remote server 710. Under either of the client render modes, the remote server 710 may send, to the client device 705, position information of the middle portion 865, and instruct the client device 705 to render the content and display the rendered content on that portion. For example, the position information may comprise a coordinate value of a reference point (e.g., the point of the upper left corner) of the middle portion 865, the height of the middle portion 865, and/or width of the middle portion 865.

A redirection decision server 740 may switch between different modes, as may be discussed in greater detail below. Switching from the “server fetch and server render” mode to either one of the two client-render modes may be referred to as Browser Content Redirection (BCR) or simply redirection. A redirection may be helpful to save the bandwidth or other computing resources allocated to execute the virtual application by offloading some of the processing to render at least a portion of the content of the virtual application onto the client device, so that fewer resources are needed by the remote server to render the rest of the content of the virtual application. The result is that the entire content of the virtual application is displayed more quickly than if that content was rendered solely using resources of the remote server. This distributed approach to the rendering of content provides significant performance improvements in computer virtualization technology.

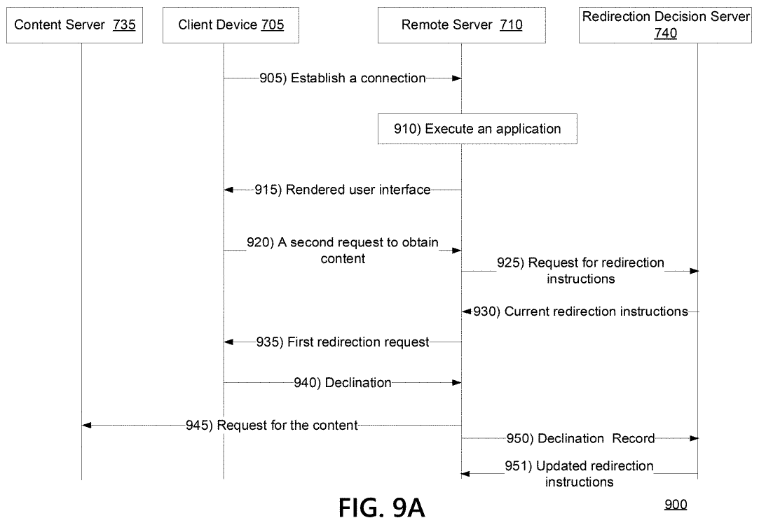

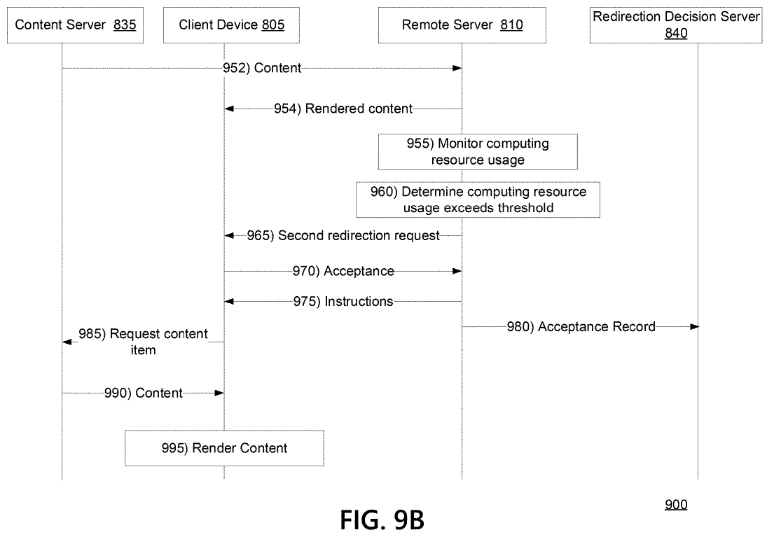

FIGS. 9A to 9B are a sequence diagram depicting processes for content redirection. The steps of sequence 900 may be performed by a system comprising the client device 705, remote server 710, content server 735, and redirection decision server 740 as depicted in FIG. 8. Alternatively or additionally, some or all of the steps of method 900 may be performed by one or more other computing devices. The steps of method 900 may be modified, omitted, and/or performed in other orders, and/or other steps added.

At step 905, the client device 705 may establish a connection with the remote server 710. The connection may comprise one or more channels (e.g., virtual channels, SaaS channels, etc.). The client device 705 may also send a request, to the remote server 710, to execute an application hosted on the remote device 710. The connection may be configured to transfer content (e.g., text, pictures, videos) between the application hosted on the remote server 710 and the client device 705. Content may be processable to render graphics of a user interface for the application.

At step 910, the remote server 710 may execute the application and render the user interface (e.g., a graphical user interface).

At step 915, the remote server 710 may send the rendered user interface to the client device 705. The user interface may be displayed via a display on or in communication with the client device 705. For the purpose of simplicity, the rendering of the user interface and sending the rendered user interface are described in FIGS. 9A to 9B once. However, it is appreciated that if the user interface changes over time during the execution of the virtual application, the remote server 710 may continually render an updated user interface and send the updated user interface to the client device 705 throughout the execution of the application.

At step 920, the client device 705 may send, to the remote server 710, a second request to obtain content from a content server 735. The application may comprise a container (e.g., a browser container) configured to display content (e.g., videos). The user may request content to be displayed by inputting an address of the content or clicking a link to the content. The content may be stored at a content server 735 and may be accessed by the remote server 710 via a URL. The virtual application may be configured to display the content at a designated area of the user interface (e.g., the middle portion 865 of the user interface 855 in FIG. 8). For example, the remote server 710 may send, to the client device 705, position information of the middle portion 865, and instruct the client device 705 to render the content and display the rendered content on that portion. For example, the position information may comprise a coordinate value of a reference point (e.g., the point of the upper left corner) of the middle portion 865, the height of the middle portion 865, and/or width of the middle portion 865. If the designated area changes (e.g., based on an input instruction), new position information (e.g., new coordinate values) may be sent to the client device 705 so that the client device 705 may adjust the position to display the rendered user interface.

At step 925, the remote server 710 may send a request to the redirection decision server 740 to obtain redirection instructions. The instructions may indicate under what conditions a request for redirection (e.g., a request to prompt the user to allow the client device 705 to render the content) is to be sent to the client device 705.

The instructions may indicate the remote server 710 requests a redirection after the remote server 710 determines that processing the content (e.g., rendering the content and/or transferring the content) may use an amount of computing resource that exceeds or is expected to exceed a threshold. The computing resources may comprise at least one of bandwidth usage or processor usage (e.g., CPU or GPU usage). The bandwidth usage may comprise the amount of bandwidth consumed during which the remote server 710 obtains the content from content server 735, and/or the amount of bandwidth consumed during which the remote server 710 sends the rendered content to the client device 705. For example, the instructions may indicate that if the transferring of the rendered content to the client device 705 consumes more than a certain number (e.g., 10 Mbit/s) of bandwidth, a redirection may be requested. Additionally or alternatively, the instructions may indicate if the transferring of the rendered content to the client device 705 consumes more than a certain percentage (e.g., 60%) of bandwidth allocated to a channel between the remote server 710 and the client device 705, a redirection may be requested. Additionally or alternatively, the instructions may indicate a threshold associated with the processor used for processing the data received from the content server 735 to generate the rendered content. Similar to the threshold of bandwidth usage, the threshold of processor usage may be either an absolute amount or a percentage of a total amount of processor resources allocated to execute the virtual application or allocated to the virtual machine that executes more than one virtual application requested by this user.

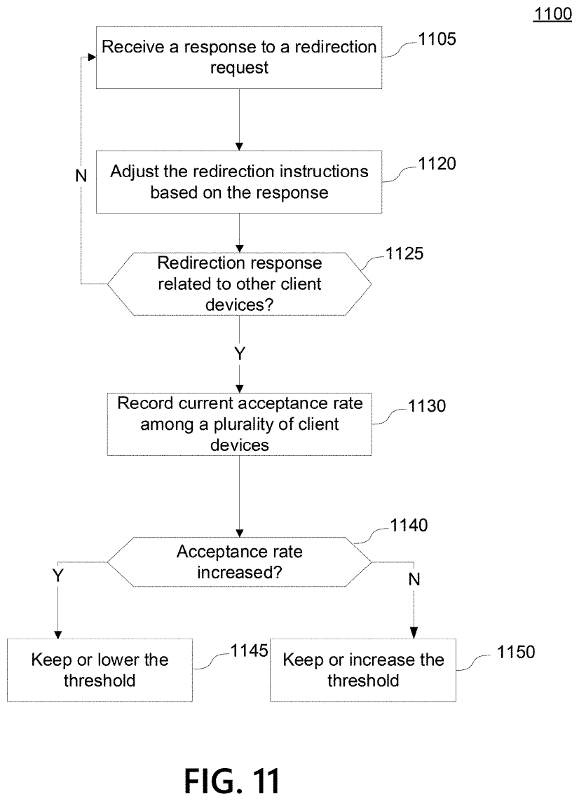

The threshold may be determined based on a variety of factors and may be associated with the user and/or the source of the content. For example, an initial threshold may be set manually and then the threshold may be adjusted based on whether the user previously accepted or declined a similar redirection request, as may be discussed in FIG. 11 for further details. In another example, the threshold may be determined based on whether the client device 705 is a thick device or a thin device. If the client device 705 is a thick device (e.g., having a CPU with a great processing capacity), the lower threshold may be set up because rendering the content by the client device 705 may significantly improve the speed. By contrast, if the client device 705 is a thin device (e.g., having less processing capacity), a higher threshold may be set up. In another example, the threshold may be determined based on whether the network environment associated with the client device 705 and/or the network environment associated with the content server 735 is secure. If the network environment is secure, a lower threshold may be set up because there may be less risk to obtaining the content by the client device 705. If the network environment is not quite secure, a higher threshold may be set up because the benefit of having a higher speed may be overweighed by potential risks. Alternatively, a “server fetch and client render” mode may be used in a network environment that is less secure.

In another example, the redirection instructions may indicate that the remote server 710 requests an initial redirection before the remote server 710 starts to obtain the content in the first place. For example, the initial redirection request may be sent based on the content is not stored on the remote server 710. In another example, the initial request may be based on processing the content is expected to use an amount of computing resource that exceeds a threshold. The expectation may be based on historical data associated with the source of the content. For example, if the source of the content is a source that previously consumed a large amount of computing resource when the remote server 710 requested other content from the source, the redirection policy may indicate an initial redirection request may be sent before the remote server 710 starts to obtain the current content in the first place. For example, if the source is a video website, it may be expected that the content is also a video and therefore may take a large amount of computing resource. By contrast, if the source of a content item is a website that displays purely texts, it may be expected that processing (e.g., rendering or transporting) the content may not use a large amount of computing resource and the remote server 710 may start with rendering the content by itself without sending an initial request.

At step 930, the redirection decision server 740 may send, to the remote server 710, current redirection instructions for the client device 705. The current redirection instructions may be initial instructions set up based on a default rule, or may be undated instructions based on various criteria such as discussed in FIG. 11 below. If the remote server 710 determines, based on the redirection instructions, that a redirection request is to be sent to the client device 705 under current circumstances, the remote server 710 may proceed step 935.

At step 935, the remote server 710 may send a first redirection request, to the client device 705, to adopt a redirection. For example, the first redirection request may be an initial redirection request before the remote server 710 starts to obtain the content in the first place, or may be a redirection request sent after the remote server 710 determines the processing of the content uses an amount of computing resource exceeding a threshold (e.g., current CPU usage associated with rendering the content is 48% while the threshold is 45%).

At step 940, the client device 705 may send a response indicating the prompt is declined. The user may decline the prompt and send the response via the client device 705.

At step 945, the remote server 710 may send, to the content server 735, a request for at least a portion of the content based on the declination of the first redirection request. For example, if the content is a video, the at least a portion of the content may comprise a certain amount of data frames (e.g., data frames corresponding to the first five minutes) of the video. A determination as to whether to redirect the content on the client device 705 may be determined again at a later time (e.g., after the first five minutes of the video has been displayed).

At step 950, the remote server 710 may send, to the redirection decision server 740, a record comprising the declination. The declination record may be used by the redirection decision server 740 to update the redirection instructions. The update of the redirection instructions may be discussed in greater detail below in FIG. 11.

At step 951, the redirection decision server 740 may send updated redirection instructions to the remote server 710 if the redirection instructions are updated. For example, after the first redirection request is declined, the threshold associated with one or more types of computing resources may be increased (e.g., the bandwidth consumption may be increased from 45% to 50%). It is appreciated that the redirection instructions may be updated at any time point during the process described in connection with FIGS. 9A to 9B, and/or may be performed for any number of times (e.g., performed once, performed more than once, or not performed at all). It is described once in connection with FIGS. 9A to 9B only for simplicity.

Referring to FIG. 9B, at step 952, the content server 735 may send the content (e.g., one or more data frames of the content) to the remote server 710. The remote server 710 may process the data of the content. For example, the remote server 710 may decode the data, render a new user interface comprising the content.

At step 954, the remote server 710 may send the rendered content to the client device 705. If the content is a content item of which the output via the user interface constantly changes (e.g., a video), the remote server 710 may continually send, to the client device 705, data reflecting the updated user interface. The client device 705 may display the rendered user interface.

At step 955, the remote server 710 may monitor computing resource usage associated with processing the content (e.g., obtaining the content, rendering the content, and/or sending the rendered content to the client device 705). For example, the resource consumption data may be obtained by the local monitor agent 723 by calling a system API. The step 955 may be performed simultaneously with step 954.

At step 960, the remote server 710 may determine the computing resource usage exceeds a threshold by comparing the monitoring results obtained at step 955 with the threshold. The threshold may correspond to a type of computing resource (e.g., bandwidth) and may have been updated at step 951 as discussed above. For example, the original threshold of bandwidth usage may be 45% of the total bandwidth allocated to a dedicated channel, and the bandwidth usage at the time the first redirection request was sent at step 935 may be 46%. After the user declined the first redirection request, the redirection decision server 740 may increase the threshold of bandwidth usage from 45% to 50%. Then, the remote server 710 may keep monitoring the bandwidth usage associated with transferring the rendered content. Five minutes later, the remote server 710 may determine the current bandwidth usage is 52% of the dedicated channel and therefore may exceed the updated threshold of bandwidth usage.

At step 965, the remote server 710 may send a second redirection request to the client device 705 to prompt the user to adopt a redirection. The second redirection request may be sent based on the determination made at step 960.

At step 970, the client device 705 may accept the prompt and send the acceptance back to the remote server 710.

At step 975, the remote server 710 may provide instructions, to the client device 705, to render a portion of the content locally on the client device 705 rather than on the remote server 710. If the redirection is to switch from the “server fetch and server render” mode to the “client fetch and client render” mode, the instructions may comprise a first instruction to obtain the content and a second instruction to overlay the display of the content to an area within the rendered user interface.

The first instruction may comprise the address of the content (e.g., an URL), the portion of the content to be obtained, or other information of the content. For example, the content is a video, the first instruction may comprise an identifier of a data frame that indicates the first data frame which the client device 705 may start to obtain. For example, by the time the first instruction is sent, the remote server 710 may have already rendered the first 20 seconds of the video. The remote server 710 may determine to continue rendering the video for an amount of time (e.g., 5 seconds) to allow the client device 705 to receive and/or process the redirection instructions, and/or to obtain at least a portion of the content from the content server. The remote server 710 may instruct the client device 705 to obtain and render data frames starting at a particular data frame corresponding to a time of 5 seconds later in the content. This may be helpful to allow a smooth transition from server-render mode to client-render mode because it may minimize the gap time during the transition. The first instruction may also comprise authentication information to access the content. For example, if the authentication information (e.g., user name, credentials) is stored on the remote server 710, the remote server 710 may send the authentication information to the client device 705 via a secured link, or the remote server 710 may create a token (e.g., a temporary token) for the client device 705 to be used to obtain the content at the content server 735. In the example where a temporary token is to be used, the remote server 710 may also send the temporary token to the content server 735 via a secured link.

The second instruction may comprise information to generate an overlay in which to render the content within an area (e.g., a pre-determined area) of the user interface. For example, in the example shown in FIG. 8, the rendered content may be overlaid to the area, in the user interface of a virtual desktop 855, corresponding to the middle portion 865 of the web browser. The second information may comprise the position of the middle portion 865.

If the redirection is to switch from the “server fetch and server render” mode to the “server fetch and client render” mode, the instructions may comprise an instruction similar to the second instruction discussed above. However, instead of instructing the client device 705 to obtain the content, the remote server 710 may send, to the client device 705, the unrendered content. Except that the content may be obtained by the client device 705 from the remote server 710 instead of from the content server 735, the operation of a “client fetch and client render” mode is otherwise similar to a “server fetch and client render” mode. Steps 985 to 995 below will discuss the “client fetch and client render” mode as an example.

At step 980, the remote server 710 may send, to the redirection decision server 740, a record comprising the acceptance received from the client device 705. The redirection decision server 740 may record the acceptance. The acceptance record may be used to update the redirection instructions, as may be discussed in greater detail in FIG. 11 below.

At step 985, the client device 705 may send a request, to the content server 735, of at least a portion of the content. The portion of the content may be identified in the first instruction as discussed above in step 975. The request may also comprise authentication information as discussed above in step 975.

At step 990, the content server 735 may send at least a portion of the content to the client device 705. The at least a portion of the content may be used by the client device 705 to generate the rendered content by using native or local computing resources such as processors and memory of the client device 705.

At step 995, the client device 705 may render the content at the position as indicated in the second instruction. After the redirection is adopted, the user may choose to disable the redirection. If the user chooses to disable the redirection, a “server fetch and server render” mode may be adopted again and the remote server 710 may start to obtain and render the content again.

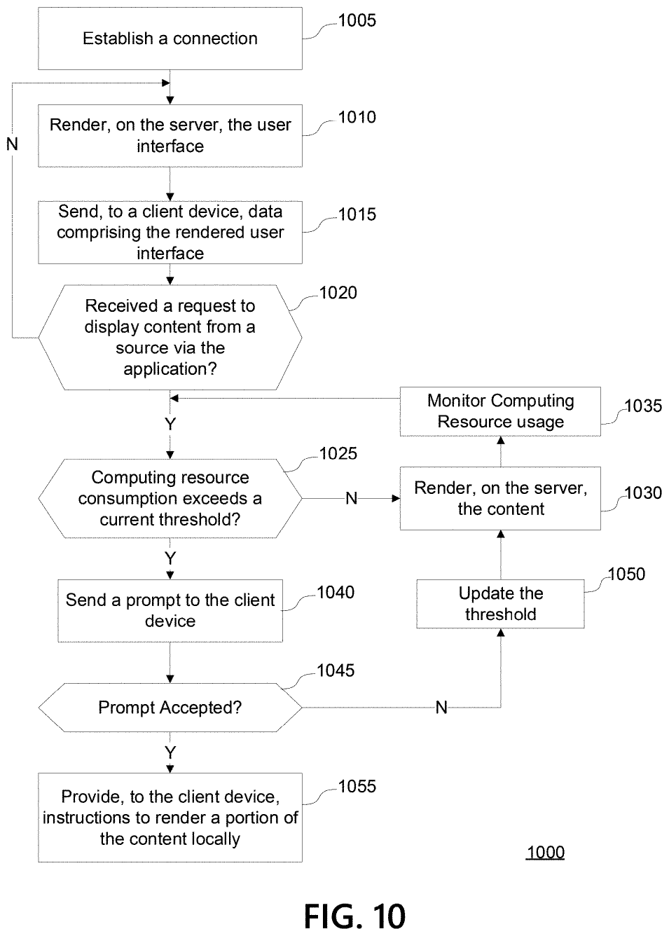

FIG. 10 depicts a flow chart for content redirection. The steps of method 1000 may be performed by a system comprising the remote server 710 and redirection decision server 740 as depicted in FIG. 7. Alternatively or additionally, some or all of the steps of method 1000 may be performed by one or more other computing devices. The steps of method 1000 may be modified, omitted, and/or performed in other orders, and/or other steps added.

At step 1005, the system may establish a connection with a client device 705. The connection may be established similar to as described in step 905. The connection may be configured to transfer content between an application, hosted on the system, and the client device 705. Content in the application may be processable to render graphics of a user interface for the application.

At step 1010, the system may execute the application based on the instructions received from the client device 705 by rendering the user interface of the application. The execution of the application and/or the rendering of the user interface may be similar to as described at step 910.

At step 1015, the system may send, to the client device 705, the rendered user interface, similar to as described at step 915.

At step 1020, the system may determine, while the rendered user interface is displayed on the client device 705, whether a second request, to obtain content from a source (e.g., content server 735) and display the content via the rendered user interface, is received. If no such request is received, the system may keep executing the application until the application is closed by the user. If such a second request is received, the method may proceed to step 1025. The second request may comprise an address of the source and may be a request similar to as described in step 920.

At step 1025, the system may determine whether an amount of computing resource usage associated with causing the content to be rendered by the remote server 710 (e.g., obtaining the content, rendering the content, and sending the rendered content to the client device 705) exceeds a threshold. The threshold may be indicated by the redirection instructions similar to described in step 925 or 951. The threshold may be determined or updated by the method 1100 described in FIG. 11 below. The amount of computing resource usage may be current computing resource usage determined by the system (e.g., based on monitoring the computing resource usage) similar to as described at step 955, or the amount of computing resource usage may be an expected computing resources usage determined based on previous requests to obtain contents from the source of the current content. For example, an expected computing resource usage may be determined by retrieving, from a database (e.g., redirection database 745 in FIG. 7), data indicating an average amount of computing resource usage associated with causing a plurality of contents, associated with the source, to be rendered by the remote server 710. If the expected computing resource usage exceeds a threshold, the redirection instructions may indicate, as discussed above, that an initial redirection request is to be sent to the client device 705 before the system starts to obtain the content from the content server 735 in the first place. If the system determines that the amount of computing resource usage, associated with causing the content to be rendered by the remote server 710, does not exceed a threshold, the method may proceed to step 1030.

At step 1030, the system may render, on the remote server 710, the content. The system may send the rendered content to the client device 705, similar to as described at step 945.

At step 1035, the system may monitor the computing resource usage associated with causing the content to be rendered by the remote server 710. For example, the resource usage or consumption may be obtained by the local monitor agent 723 by calling a system API. The system call may be made from time to time (e.g., periodically) so that the resource usage or consumption data may be updated from time to time. After the resource usage or consumption data is updated, the method may proceed back to step 1025 to determine whether the amount of computing resource usage associated with causing the content to be rendered by the remote server 710 exceeds the threshold or not.

Referring back to step 1025, if the system determines that the amount of computing resource usage associated with causing the content to be rendered by the remote server 710 exceeds the threshold, the method may proceed to step 1040. At step 1040, the system may send a prompt to the client device 705 to request a redirection. The prompt may be similar to the first redirection request described at step 935 and/or the second redirection request described at step 965. Additionally or alternatively, the system may, prior to sending the prompt, send a third request, to the client device 705, to request data indicating the native computing resource usage on the client device 705 (e.g., CPU on the client device 705). The prompt may be sent after a response indicating that the native computing resource usage on the client device 705 does not exceed a second threshold. This way, redirection may be prompted based on the client device 705 having spare computing resources to render the content. This may be helpful to improve the chance of an effective redirection.

At step 1045, the system may determine whether the prompt is accepted or declined. If the prompt is declined, the method may proceed to step 1050. At step 1050, the system may record the declination and may update the threshold based on the declination, as may be discussed in FIG. 11 in greater detail. The method may then proceed back to step 1030, where the remote server 710 may render the content and send the rendered content to the client device 705.

Referring back to step 1045, if the prompt is accepted, the method may proceed to step 1055. At step 1055, the system may provide, to the client device 705, instructions to render a portion of the content locally on the client device 705 rather than on the system. For example, the system may send a message comprising a first instruction to obtain the content and a second instruction to overlay the display of the content to an area within the rendered user interface. The first instruction and the second instruction may be similar to the first instruction and the second instruction described at step 975 respectively. The client device 705, after receiving the instructions, may render the content similar to as described at step 995 until the content is ended or the user disables the redirection. The acceptance may also be recorded and used by the system to update the redirection instructions.

FIG. 11 depicts a flow chart for updating a redirection instructions. The steps of method 1100 may be performed by a system comprising the remote server 710 and redirection decision server 740 as depicted in FIG. 7. Alternatively or additionally, some or all of the steps of method 1100 may be performed by one or more other computing devices. The redirection instructions may be used in connection with method 900 described in FIGS. 9A to 9B, or may be used in connection with method 1000 described in FIG. 10. The steps of method 1100 may be modified, omitted, and/or performed in other orders, and/or other steps added.

At step 1105, the system may receive a response to a redirection request. The response may be received from a client device 705 in response to a previously redirection request (e.g., the first redirection request in step 935, the second redirection request in step 965, or the prompt in step 1040). The client device 705 may have established a virtual session with the system to execute a virtual application, and have requested a content item to be displayed in a user interface of the virtual application. A redirection request may have been sent to the client device 705 based on current redirection instructions.

At step 1120, the system may adjust the redirection instructions (e.g., a redirection threshold) based on the response. For example, the threshold may be adjusted based on whether the redirection request is accepted or declined.

If the redirection request is accepted, the threshold may be kept without adjusting or may be decreased (e.g., a bandwidth usage threshold may be decreased from 50% to 45%). The threshold may be associated with the source of the content. If the threshold is decreased, the next time the client device 705 requests to visit the source (e.g., a request to have another content from the source rendered), a redirection request may be sent earlier. Additionally or alternatively, the redirection instructions may be updated to indicate that the next time a user visits the source, the system may send an initial redirection request before obtaining any data from the source in the first place.

If the prompt is declined, the system may increase a threshold in the redirection instructions. The increased threshold may be used during the rendering of the same content, or may be used during the rendering of another content in the future. Additionally or alternatively, if the current instructions indicate an initial redirection request is to be sent before the system starts to obtain the content in the first place, the system may update the redirection instructions by canceling the initial redirection request, so that the next time the user of the client device 705 requests to visit the source, the system may start with obtaining and rendering at least a portion of the content by itself and monitoring the computing resource usage during the obtaining and rendering.

At step 1125, the system may determine whether the redirection response is related to redirection decisions made by other client devices. The determination may be made based on the type of computing resource of which the amount of usage exceeds the threshold. For example, a redirection based on high bandwidth consumption may not be related to other client devices because bandwidth consumption may strongly correlate to the size of the content being transferred. Therefore, if some client devices accepted a redirection to render content obtained from a certain source due to a high bandwidth consumption, other client devices are also likely to accept a redirection to render content obtained from that source because their bandwidth consumptions are also likely to be high. By contrast, for example, a redirection based on high CPU usage may be unrelated to other client devices, because CPU usage at a particular moment may not strongly correlate to the size of the content rendered for the virtual application. Instead, CPU usage may depend on the overall computing environment (e.g., the operation of other applications on the same physical or virtual machine at that particular time). Even if the CPU usage to execute the application on one client device is high at a particular time, the CPU usage to execute the application next time on this, or another, client device may be low. Therefore, a redirection made by one client device based on high CPU usage may be unrelated to the redirection made by other client devices or by this client device at another time. If the system determines that the redirection is not related to other client devices, the threshold updates based on the current redirection response may be completed and the system may wait for the next redirection response. If the system determines that the redirection response is related to other client devices, the method may proceed to step 1130.

At step 1130, the system may record the current acceptance rate among a plurality of client devices as a first acceptance rate. The first acceptance rate may indicate the percentage of client devices, who accept the redirection request when the computing resource usage level is equal to or lower than the current threshold, of a plurality of client devices that have requested contents from the source of this content. For example, the current bandwidth usage threshold is 45%. By the time the response is received, a total number of 100 client devices have requested from the source of the content involved in this response. Among the 100 devices, 30 client devices indicated acceptance of redirection requests when the bandwidth usage is 45% or lower. Then, the first acceptance rate may be 30%.

At step 1140, the system may determine whether a current acceptance rate has been increased or not, compared with the first acceptance rate. For example, the determination may be made at a certain time point after the first acceptance rate is recorded (e.g., 10 minutes later). In another example, the determination may be made the next time the client device requests content from the same source. For example, when the system receives the request from a client device for content from the same source the next time, the system determines that 6 more client devices have visited the source since the first acceptance rate has been recorded. Among the 6 devices, 2 client devices indicate acceptance of a redirection request when the bandwidth usage is 45% or lower. 1 client device received a redirection request but declined the request. The other 3 devices had redirection instructions having a higher threshold and therefore did not receive any redirection request when the bandwidth usage is at 45% or lower. Therefore, the total number of client devices who have visited the source may be changed from 100 to 106. The number of client devices that indicated acceptance of the redirection request when the bandwidth usage is at 45% or lower may be changed from 30 to 32. The current acceptance rate may be 32/106=30.2%. Therefore, the system may determine the current acceptance rate is greater than the first acceptance rate. An increased acceptance rate may indicate that more client devices are willing to adopt a redirection when visiting this source under the current threshold. Similarly, a decreased acceptance rate may indicate that fewer client devices are willing to adopt a redirection when visiting this source under the current threshold. If the acceptance rate is increased, the method may proceed to step 1145. If the acceptance rate is not increased, the method may proceed to step 1150.

At step 1145, the system may either keep or decrease the threshold. For example, if the response received at step 1105 is to decline the redirection, the system may keep the threshold. If the response received at step 1105 is to accept the redirection, the system may decrease the threshold. This is because, a larger percentage of client devices indicates acceptance of the redirection to this source under the current threshold (or a lower threshold) may indicate the current threshold (or a lower threshold) is a favorable threshold.

At step 1150, the system may keep or increase the threshold. For example, if the response received at step 1105 is to decline the redirection, the system may increase the threshold. If the response received at step 1105 is to accept the redirection, the system may keep the threshold. This is because, a smaller percentage of client devices are willing to accept the redirection to this source under the current threshold (or a lower threshold) may indicate the current threshold (or a lower threshold) is not a favorable threshold.

The following paragraphs (M1) through (M9) describe examples of methods that may be implemented in accordance with the present disclosure.

(M1) A method comprising: establishing, by a remote computing device, a connection in which to transfer content between an application hosted on the remote computing device and a client device, the content being processable to render graphics of a user interface for the application; determining, by the remote computing device, that to render the content of the application with use of one or more resources of the remote computing device would exceed a threshold; and providing, by the remote computing device, instructions to the client device, the instructions enable the client device to render a portion of the content locally on the client device rather than on the remote computing device.

(M2) A method may be performed as described in paragraph (M1) wherein the one or more resources comprise at least one of: bandwidth to transfer the content; or CPU usage of a CPU, on the remote computing device, to process the content.

(M3) A method may be performed as described in any of paragraphs (M1) through (M2) wherein the content comprises at least a portion of a webpage.

(M4) A method may be performed as described in any of paragraphs (M1) through (M3) wherein the determining that to render the content of the application with use of one or more resources of the remote computing device would exceed a threshold comprises: receiving, an address indicating a source of at least a portion of the content; and retrieving, from a database, data indicating an average amount of resource consumption associated with causing content, from the source, to be rendered by the remote computing device.

(M5) A method may be performed as described in any of paragraphs (M1) through (M4), wherein the determining that to render the content of the application with use of one or more resources of the remote computing device would exceed a threshold comprises: monitoring current resource allocated to causing the content rendered by the remote computing device.

(M6) A method may be performed as described in any of paragraphs (M1) through (M5), further comprising: sending a request, to the client device, to request data indicating CPU usage of a CPU on the client device; and receiving a response, to the request, that indicates the CPU usage of the CPU, on the client device, does not exceed a second threshold; and wherein the providing instructions is further based on the response.

(M7) A method may be performed as described in any of paragraphs (M1) through (M6), further comprising: sending, to the client device, a prompt to obtain the content via the client device; and receiving an acceptance to the prompt; and wherein the providing instructions is further based on the prompt.

(M8) A method may be performed as described in any of paragraphs (M1) through (M7), further comprising: adjusting, based on the acceptance to the prompt, the threshold.

(M9) A method may be performed as described in any of paragraphs (M1) through (M8), further comprising: sending, to the client device, a first prompt to obtain the content via the client device; receiving a declination to the first prompt; determining an increased number of second client devices each has accepted a prompt to obtain a second content from a source of the content; and sending, to the client device and based on the determining, a second prompt to obtain the content via the client device.

The following paragraphs (S1) through (S6) describe examples of systems that may be implemented in accordance with the present disclosure.

(S1) A system comprising: a remote computing device, and a client device configured to establish a connection with the remote computing device; wherein the remote computing device comprises: one or more processors; and memory storing instructions that, when executed by the one or more first processors, configured the remote computing device to: establish the connection in which to transfer content between an application hosted on the remote computing device and the client device, the content being processable to render graphics of a user interface for the application; determine that to render the content of the application with use of one or more resources of the remote computing device would exceed a threshold; and provide instructions to the client device, the instructions enable the client device to render a portion of the content locally on the client device rather than on the remote computing device.

(S2) A system may be performed as described in paragraph (S1), wherein the one or more resources comprise at least one of: bandwidth to transfer the content; or CPU usage of a CPU, on the remote computing device, to process the content.

(S3) A system may be performed as described in any of paragraphs (S1) through (S2), wherein the content comprises at least a portion of a webpage.

(S4) A system may be performed as described in any of paragraphs (S1) through (S3), wherein the instructions, when executed by the one or more processors, cause the remote computing device to determine that to render the content of the application with use of one or more resources of the remote computing device would exceed a threshold by performing actions comprising: receiving, an address indicating a source of at least a portion of the content; and retrieving, from a database, data indicating an average amount of resource consumption associated with causing content, from the source, to be rendered by the remote computing device.

(S5) A system may be performed as described in any of paragraphs (S1) through (S4), wherein the instructions, when executed by the one or more processors, further cause the remote computing device to: sending a request, to the client device, to request data indicating CPU usage of a CPU on the client device; and receiving a response, to the request, that indicates the CPU usage of the CPU, on the client device, does not exceed a second threshold; and wherein the providing instructions is further based on the response.

(S6) A system may be performed as described in any of paragraphs (S1) through (S5), wherein the instructions, when executed by the one or more processors, further cause the remote computing device to: send, to the client device, a first prompt to obtain the content via the client device; receive a declination to the first prompt; determine an increased number of second client devices each has accepted a prompt to obtain a second content from a source of the content; and send, to the client device and based on the determining, a second prompt to obtain the content via the client device.

The following paragraphs (CRM1) through (CRM5) describe examples of computer-readable media that may be implemented in accordance with the present disclosure.

(CRM1) A non-transitory computer-readable medium storing instructions that, when executed, cause a remote computing device to establish the connection in which to transfer content between an application hosted on the remote computing device and the client device, the content being processable to render graphics of a user interface for the application; determine that to render the content of the application with use of one or more resources of the remote computing device would exceed a threshold; and provide instructions to the client device, the instructions enable the client device to render a portion of the content locally on the client device rather than on the remote computing device.

(CRM2) A non-transitory computer-readable medium may be performed as described in paragraph (CRM1), wherein the one or more resources comprise at least one of: bandwidth to transfer the content; or CPU usage of a CPU, on the remote computing device, to process the content.

(CRM3) A non-transitory computer-readable medium may be performed as described in any of paragraphs (CRM1) through (CRM2), wherein the content comprises at least a portion of a webpage.

(CRM4) A non-transitory computer-readable medium may be performed as described in any of paragraphs (CRM1) through (CRM3), wherein the instructions, when executed by the one or more processors of the remote computing device, cause the remote computing device to determine that to render the content of the application with use of one or more resources of the remote computing device would exceed a threshold by performing actions comprising: receiving, an address indicating a source of at least a portion of the content; and retrieving, from a database, data indicating an average amount of resource consumption associated with causing content, from the source, to be rendered by the remote computing device.

(CRM4) A non-transitory computer-readable medium may be performed as described in any of paragraphs (CRM1) through (CRM3), wherein the instructions, when executed by the one or more processors of the remote computing device, cause the remote computing device to determine that to render the content of the application with use of one or more resources of the remote computing device would exceed a threshold by monitoring current computing resource allocated to causing the content rendered by the remote computing device.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
establishing, by a remote computing device, a connection in which to transfer content between an application hosted on the remote computing device and a client device, the content being processable to render graphics of a user interface for the application;
determining, by the remote computing device, that to render the content of the application with use of one or more resources of the remote computing device would exceed a threshold; and
providing, by the remote computing device, instructions to the client device, the instructions enable the client device to render a portion of the content locally on the client device rather than on the remote computing device.

2. The method of claim 1, wherein the one or more resources comprise at least one of:
bandwidth to transfer the content; or
CPU usage of a CPU, on the remote computing device, to process the content.

3. The method of claim 1, wherein the content comprises at least a portion of a webpage.

4. The method of claim 1, wherein the determining that to render the content of the application with use of one or more resources of the remote computing device would exceed a threshold comprises:
receiving, an address indicating a source of at least a portion of the content; and
retrieving, from a database, data indicating an average amount of resource consumption associated with causing content, from the source, to be rendered by the remote computing device.

5. The method of claim 1, wherein the determining that to render the content of the application with use of one or more resources of the remote computing device would exceed a threshold comprises:
monitoring current resource allocated to causing the content rendered by the remote computing device.

6. The method of claim 1, further comprising:
sending a request, to the client device, to request data associated with CPU usage of a CPU on the client device; and
receiving a response, to the request, that indicates the CPU usage of the CPU, on the client device, does not exceed a second threshold; and
wherein the providing instructions is further based on the response.

7. The method of claim 1, further comprising:
sending, to the client device, a prompt to obtain the content via the client device; and
receiving an acceptance to the prompt; and
wherein the providing instructions is further based on the prompt.

8. The method of claim 7, further comprising:
adjusting, based on the acceptance to the prompt, the threshold.

9. The method of claim 1, further comprising:
sending, to the client device, a first prompt to obtain the content via the client device;
receiving a declination to the first prompt;
determining an increased number of second client devices each has accepted a prompt to obtain a second content from a source of the content; and
sending, to the client device and based on the determining, a second prompt to obtain the content via the client device.

10. A system comprising:
a remote computing device, and
a client device configured to establish a connection with the remote computing device;
wherein the remote computing device comprises:
one or more processors; and
memory storing instructions that, when executed by the one or more first processors, configured the remote computing device to:
establish the connection in which to transfer content between an application hosted on the remote computing device and the client device, the content being processable to render graphics of a user interface for the application;
determine that to render the content of the application with use of one or more resources of the remote computing device would exceed a threshold; and
provide instructions to the client device, the instructions enable the client device to render a portion of the content locally on the client device rather than on the remote computing device.

11. The system of claim 10, wherein the one or more resources comprise at least one of:
bandwidth to transfer the content; or
CPU usage of a CPU, on the remote computing device, to process the content.

12. The system of claim 10, wherein the content comprises at least a portion of a webpage.

13. The system of claim 10, wherein the instructions, when executed by the one or more processors, cause the remote computing device to determine that to render the content of the application with use of one or more resources of the remote computing device would exceed a threshold by performing actions comprising:
receiving, an address indicating a source of at least a portion of the content; and
retrieving, from a database, data indicating an average amount of resource consumption associated with causing content, from the source, to be rendered by the remote computing device.

14. The system of claim 10, wherein the instructions, when executed by the one or more processors, further cause the remote computing device to:
sending a request, to the client device, to request data associated with CPU usage of a CPU on the client device; and
receiving a response, to the request, that indicates the CPU usage of the CPU, on the client device, does not exceed a second threshold; and
wherein the providing instructions is further based on the response.

15. The system of claim 10, wherein the instructions, when executed by the one or more processors, further cause the remote computing device to:
send, to the client device, a first prompt to obtain the content via the client device;
receive a declination to the first prompt;
determine an increased number of second client devices each has accepted a prompt to obtain a second content from a source of the content; and
send, to the client device and based on the determining, a second prompt to obtain the content via the client device.

16. A non-transitory computer-readable medium storing computer instruction that, when executed by one or more processors of a remote computing device, cause the remote computing device to:
establish the connection in which to transfer content between an application hosted on the remote computing device and the client device, the content being processable to render graphics of a user interface for the application;
determine that to render the content of the application with use of one or more resources of the remote computing device would exceed a threshold; and
provide instructions to the client device, the instructions enable the client device to render a portion of the content locally on the client device rather than on the remote computing device.

17. The non-transitory computer-readable medium of claim 16, wherein the one or more resources comprise at least one of:
bandwidth to transfer the content; or
CPU usage of a CPU, on the remote computing device, to process the content.

18. The non-transitory computer-readable medium of claim 16, wherein the content comprises at least a portion of a webpage.

19. The non-transitory computer-readable medium of claim 16, wherein the instructions, when executed by the one or more processors of the remote computing device, cause the remote computing device to determine that to render the content of the application with use of one or more resources of the remote computing device would exceed a threshold by performing actions comprising:
receiving, an address indicating a source of at least a portion of the content; and
retrieving, from a database, data indicating an average amount of resource consumption associated with causing content, from the source, to be rendered by the remote computing device.

20. The non-transitory computer-readable medium of claim 16, wherein the instructions, when executed by the one or more processors of the remote computing device, cause the remote computing device to determine that to render the content of the application with use of one or more resources of the remote computing device would exceed a threshold by monitoring current computing resource allocated to causing the content rendered by the remote computing device.
